(19) United States
(12) Patent Application Publication
(10) Pub. No.: US 2013/0108895 A1
(43) Pub. Date: May 2, 2013

(54) METHOD TO CONTROL CURRENT IN A FUEL CELL SYSTEM

(71) Applicant: PLUG POWER INC., Latham, NY (US)

(72) Inventor: Steven VanWERKHOVEN, Surrey (CA)

(73) Assignee: PLUG POWER INC., Latham, NY (US)

(21) Appl. No.: 13/665,248

(22) Filed: Oct. 31, 2012

Related U.S. Application Data
(60) Provisional application No. 61/553,656, filed on Oct. 31, 2011.

(51) Int. Cl. H01M 8/04; H02J 7/00

(52) U.S. Cl. CPC H01M 8/04089; H02J 7/00
USPC 429/9; 429/444; 429/431; 320/101

(57) ABSTRACT

A method for operating a fuel cell system includes electrically coupling the fuel cell stack to an energy storage device and an electrical demand by a load device at a substantially constant voltage. A controller controls an amount of an oxidant supply to the fuel cell stack based on the demand by the load device.

### CROSS-REFERENCE TO RELATED APPLICATIONS

This application claims priority to U.S. Provisional Application No. 61/553,656 filed on Oct. 31, 2011, the entire disclosure of which is incorporated by reference.

### TECHNICAL FIELD

This invention relates generally to fuel cells and fuel cell systems, and more particularly to methods for controlling the current output of a fuel cell by managing an oxidant flow rate.

### BACKGROUND OF THE INVENTION

Fuel cells electrochemically convert fuels and oxidants to electricity and heat and can be categorized according to the type of electrolyte (e.g., solid oxide, molten carbonate, alkaline, phosphoric acid or solid polymer) used to accommodate ion transfer during operation. Moreover, fuel cell assemblies can be employed in many (e.g., automotive to aerospace to industrial to residential) environments, for multiple applications.

A Proton Exchange Membrane (hereinafter “PEM) fuel cell converts the chemical energy of fuels such as hydrogen and oxidants such as air directly into electrical energy. The PEM is a sold polymer electrolyte that permits the passage of protons (i.e., H+ ions) from the “anode” side of the fuel cell to the “cathode” side of the fuel cell while preventing passage there through of reactant fluids (e.g., hydrogen and air gases). A Membrane Electrode Assembly (hereinafter “MEA”) is placed between two electrically conductive plates, each of which has a flow passage to direct the fuel to the anode side and oxidant to the cathode side of the PEM.

Two or more fuel cells can be connected together to increase the overall power output of a fuel cell assembly. Generally, the cells are connected in series, wherein one side of a plate serves as an anode plate for one cell and the other side of the plate is the cathode plate for the adjacent cell. Such a series of connected multiple fuel cells is referred to as a fuel cell stack. The stack typically includes means for directing the fuel and the oxidant to the anode and cathode flow field channels, respectively. The stack also usually includes a means for directing a coolant fluid to interior channels within the stack to absorb heat generated by the exothermic reaction of hydrogen and oxygen within the fuel cells. The stack also generally includes means for exhausting the excess fuel and oxidant gases, as well as produced water.

Generally, the fuel cell is supplied with fuel and oxidant in excess of what is required by the electrochemical reaction. The stoichiometric ratio (hereinafter “stoich”) indicates the amount of excess reactant and is given by the following equation:

Stoich=actual amount of reactant/minimum amount of reactant required

In order to obtain good performance and high efficiencies, fuel cells using oxygen from air as the reactant, require stoichs greater than 1. PEM fuel cells typically operate at air stoichs of 1.5-2.5.

In some fuel cell systems, the fuel cell is coupled in parallel with an energy storage device (e.g., a battery, capacitor, etc.) which is then coupled to a load. Commonly referred to as a hybrid system, peak power from the system is supplied by the energy storage device while the fuel cell provides the average power needs of the application. In most hybrid systems a voltage converter is used to convert the fuel cell stack voltage to the energy storage device voltage. In these types of systems, the fuel cell can operate independently from the energy storage device. Power output from the fuel cell is generally controlled via the voltage converter via a system controller. A current command is given by the controller, the reactant supply is increased according to the required stoichiometric ratios and then power is produced.

Another type of hybrid system eliminates the need for the voltage converter and couples the fuel cell stack directly to the energy storage device. In this system the fuel cell stack voltage, energy storage device and load voltage are equal. The current output of the fuel cell is therefore dictated by the polarization curve of the fuel cell being used. Therefore, the voltage of the system controls the current output of the fuel cell.

This system has the advantage of fewer components and decreased weight, volume and cost. However, this type of system has inherent disadvantages. In many applications, the voltage of the system is dictated by the demand load and is not controllable, therefore the fuel cell lacks independent control. This lack of control can be problematic as the fuel cell may operate outside of its normal conditions or may lead to many start and stop cycles which may reduce overall fuel cell durability.

Thus, there is a need for a means to control the fuel cell power output in a system whereby the fuel cell is directly coupled to an energy storage device.

### SUMMARY OF THE INVENTION

The present invention provides, in a first aspect, a method to control the current output of a fuel cell by varying the oxidant stoichiometric ratio. For example, a method for operating a fuel cell system includes electrically coupling a fuel stack to an energy storage device and an electrical demand by a load device at a substantially constant voltage. A controller controls the amount of an oxidant supplied to the fuel cell stack based on the demand by the load device.

The present invention provides, in a second aspect, a fuel cell system which includes a fuel cell stack, an energy storage device and a controller. The energy storage device is electrically connected to the fuel cell stack at a first voltage. A load device is electrically connected to the fuel cell stack and the energy storage device at substantially the first voltage. The controller is coupled to the stack and the load device. The controller is configured to control an amount of an oxidant supply to the stack to control the amount of current supplied by the stack in response to an amount of a demand by the load device.

### BRIEF DESCRIPTION OF THE DRAWINGS

The subject matter which is regarded as the invention is particularly pointed out and distinctly claimed in the claims at the conclusion of the specification. The foregoing and other features and advantages of the invention will be readily understood from the following detailed description of the preferred embodiments taken in conjunction with the accompanying drawings in which:

FIG. 1 is a block diagram of a fuel cell system in accordance with the invention

FIG. 2 is a typical performance curve for a fuel cell;

FIG. 3 is a comparison of the typical performance curve to a modified performance curve in accordance with the invention; and

FIG. 4 is a block diagram of another example of a fuel cell system in accordance with the invention.

### DETAILED DESCRIPTION

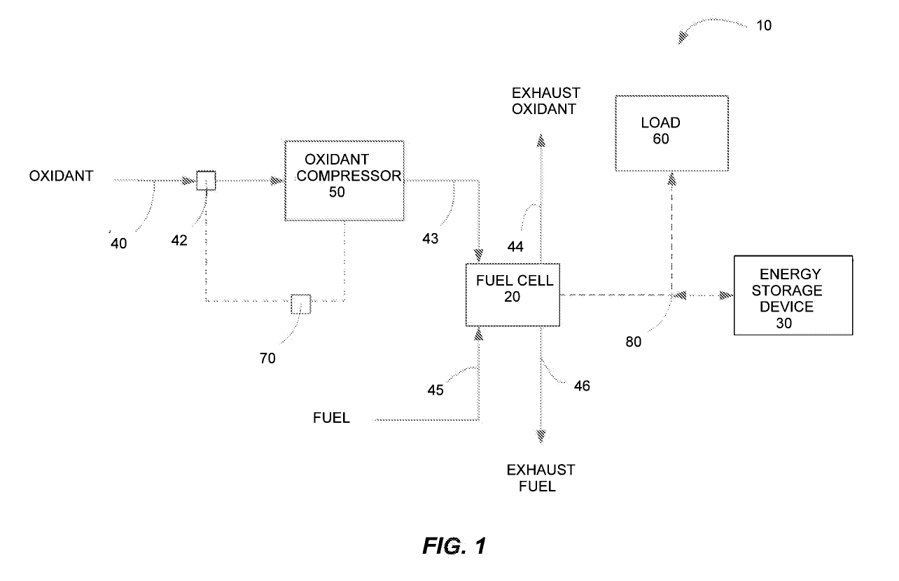

An example of a fuel cell system of the present invention is depicted in FIGS. 1-4 and described in detail herein.

In the embodiment depicted in FIG. 1, a fuel cell system 10 is referred to as the assembled, or complete, system which functionally together with all parts thereof produces electricity and typically includes a fuel cell stack 20 and an energy storage device 30 (e.g., a lithium-ion, nickel-hydride, sodium or other type of battery, or an electrolytic capacitor). Fuel cell stack 20 is supplied with fuel, for example, hydrogen, through a fuel inlet 45. Excess fuel is exhausted from the fuel cell through a fuel exhaust 46. Oxidant, for example, air, is supplied through an oxidant inlet 40 into a flow meter 42 and compressed by an oxidant compressor 50 before being fed into fuel cell stack 20 through an oxidant inlet 43. A controller 70, using a measured flow rate from flow meter 42 controls a speed of compressor 50 to achieve the desired flow rate of oxidant to the fuel cell 20. Excess oxidant is exhausted from the fuel cell stack through an oxidant exhaust 44.

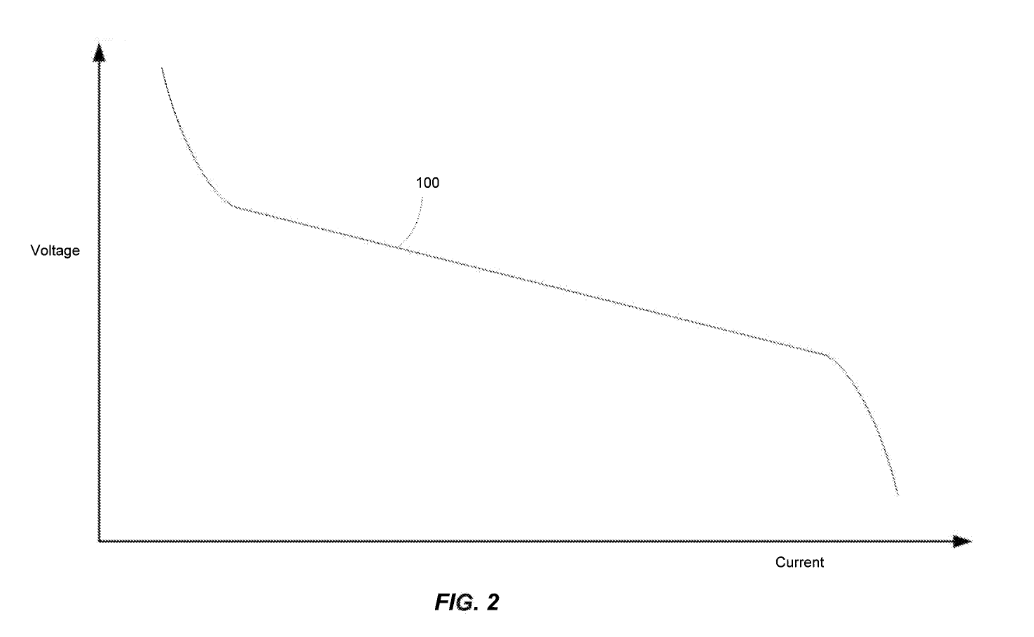

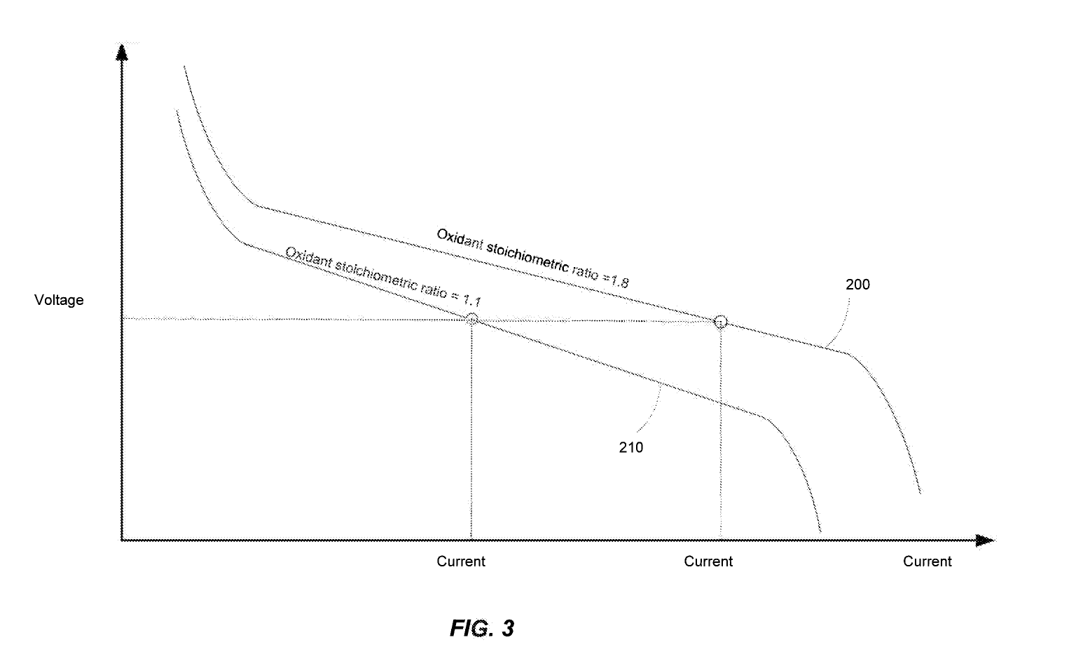

An amount of power produced by fuel cell stack 20 is defined by its polarization curve. FIG. 2. shows a typical polarization curve 100 which is a function of voltage and current. The polarization curve is also dependent on other variables including oxidant stoichiometric ratio. In general, lower stoichiometric ratios lower the polarization curve. FIG. 3 shows polarization curves 200, 210 for different oxidant stoichiometric ratios. With a lower stoichiometric ratio, polarization curve 210 will produce less current and hence less power at the same voltage as compared to polarization curve 200.

Referring to FIG. 1, an electrical demand or load 60, for example, from a load device, such as an industrial electric vehicle (e.g., a forklift truck), is connected to the energy storage device 30 and fuel cell stack 20 in parallel by electrical connection 80. Depending on the demand, power (e.g., electrical energy) may flow from energy storage device 30, fuel cell stack 20 or both. In times of high demand in excess of a maximum power output of a fuel cell stack 20, power may flow from both fuel cell stack 20 and energy storage device 30. In times of low demand, power can flow to load 60 from fuel cell stack 20, while excess power from fuel cell stack 20 may flow into energy storage device 30 to recharge it when required.

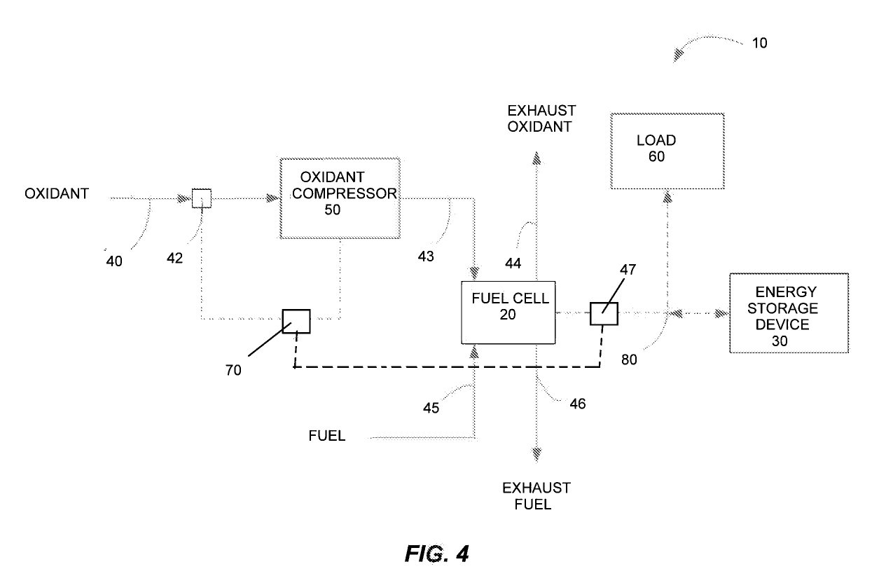

In this type of fuel cell system, a voltage of the fuel cell stack 20, energy storage device 30 and load device 60 are substantially equal. To control the output power from the fuel cell stack 20, a speed of oxidant compressor 50 may be varied by a controller 70 coupled to meter 42 and/or load device 60 to change the oxidant stoichiometric ratio. As shown in FIG. 3, this would vary the current output from fuel cell stack 20 at a substantially fixed voltage. Therefore, by controlling the oxidant flow rate the current, and hence power output of fuel cell stack 20 can be controlled. In another example, controller 70 could be coupled to a current sensing device 47 at the output of the stack as depicted in FIG. 4. A current measurement by this device provided to the controller, along with a voltage measurement of the fuel cell stack provided to the controller, would allow the controller to determine the amount of load drawn from the stack. The controller could then control the amount of oxidant needed by the load and cause the flow of oxidant to the fuel cell stack by controlling an oxidant compressor, fan, pump, or other mechanism for supplying such oxidant to the fuel cell stack.

As would be understood by one of ordinary skill in the art, controller 70 could be a computing unit of various types which has software configured to control a flow of oxidant (e.g., using a compressor, fan, pump, pressurized tank, or other oxidant supply mechanism) to a fuel cell stack (e.g., fuel stack cell 20) in response to an amount of an electrical demand and a desire to send electrical energy to such demand and/or an energy storage device (e.g., a battery, such a lithium-ion, nickel-hydride, sodium, or other battery, or an electrolytic capacitor). Further, the demand described could be an industrial vehicle, such as a forklift truck or another type of vehicle, or another electrically consuming device, which is desired to control a flow of electrical energy to.

Although preferred embodiments have been depicted and described in detail herein, it will be apparent to those skilled in the relevant art that various modifications, additions, substitutions and the like can be made without departing from the spirit of the invention and these are therefore considered to be within the scope of the invention as defined in the following claims.

What is claimed is:

1. A method for operating a fuel cell system comprising:
electrically coupling a fuel cell stack to an energy storage device and an electrical demand by a load device at a substantially constant voltage; and
a controller controlling an amount of an oxidant supplied to the fuel cell stack based on the demand by the load device.

2. The method of claim 1 further comprising increasing the amount of the oxidant r in response to an increase in an amount of the demand.

3. The method of claim 1 wherein the fuel cell stack and the energy storage device are connected in parallel to the demand.

4. The method of claim 1 further comprising power flowing from the stack and the energy storage device to the load device in response to an increase in an amount of the demand.

5. The method of claim 1 further comprising power flowing from the stack to the energy storage device in response to a decrease in an amount of the demand.

6. The method of claim 1 further comprising power flowing from the stack to the energy storage device and the load in response to a decrease in an amount of the demand.

7. The method of claim 1 further comprising a sensor determining a flow rate of the oxidant from a supply of the oxidant toward the fuel cell stack, the sensor coupled to the controller and supplying an indication of the flow rate to the controller.

8. The method of claim 7 wherein the controller controls a compressor to supply the amount of the oxidant to the fuel cell stack based on the flow rate.

9. The method of claim 1 further comprising the controller controlling a compressor to supply the amount of the oxidant to the fuel cell stack based on the demand.

10. The method of claim 1 further comprising a current sensor determining an output of current by the fuel cell stack, the current sensor coupled to the controller and supplying an indication of the current to the controller, and the controller controlling an amount of the oxidant supplied to the fuel cell stack based on the amount of the current.

11. A fuel cell system comprising
a fuel cell stack;
an energy storage device electrically connected to said fuel cell stack at a first voltage;
a load device electrically connected to said fuel cell stack and said energy storage device at substantially said first voltage; and
a controller coupled to said stack and said load device, said controller configured to control an amount of an oxidant supplied to said stack to control an amount of current supplied by said stack in response to an amount of a demand by said load device.

12. The system of claim 11 wherein said stack and said energy storage device are connected in parallel to said load device.

13. The system of claim 11 further comprising an oxidant compressor coupled to said controller and configured to supply the oxidant to said fuel cell stack.

14. The system of claim 11 wherein said controller is configured to cause power to flow from the stack and the energy storage device to the load device in response to an increase in the amount of the demand.

15. The system of claim 11 wherein said controller is configured to cause power to flow from the stack to the energy storage device in response to a decrease in the amount of the demand.

16. The system of claim 11 wherein said controller is configured to cause power to flow from the stack to the energy storage device and the load device in response to a decrease in the amount of the demand.

17. The system of claim 11 further comprising a sensor configured to determine a flow rate of the oxidant from a supply of the oxidant toward a fuel cell stack, the sensor coupled to the controller and supplying an indication of the flow rate to the controller.

18. The system of claim 11 further comprising a current sensor configured to determine an output of current by said fuel cell stack, the current sensor coupled to the controller and supplying an indication of the current to the controller to allow the controller to control an amount of the oxidant supplied to said fuel cell stack.

19. The system of claim 11 further comprising an oxidant supply mechanism coupled to said controller and configured to supply the oxidant to said fuel cell stack.
